(19) United States
(12) Patent Application Publication
(10) Pub. No.: US 2021/0224677 A1
(43) Pub. Date: Jul. 22, 2021

(54) FORECASTING MODEL GENERATION FOR TIME SERIES DATA WITH CHANGE POINT AND SEASONALITY

(71) Applicant: International Business Machines Corporation, Armonk, NY (US)

(72) Inventors: Goran Tomic, Chicago, IL (US); Damir Spisic, Cook County, IL (US); Graham Wills, Naperville, IL (US); Kevin Gasiorowski, Batavia, IL (US)

(21) Appl. No.: 16/747,999

(22) Filed: Jan. 21, 2020

(51) Int. Cl. G06N 7/00; G06K 9/62

(52) U.S. Cl. CPC G06N 7/005; G06K 9/6227

(57) ABSTRACT

A method, apparatus, system, and computer program product for creating a forecasting model for time series data. Seasonality is removed from the times series data having the seasonality and trends to form deseasoned time series data. Trend models are created for sets of candidate change points in the deseasoned time series data. The trend models are for the sets of candidate change points without the seasonality. Seasonal models are created using the time series data without the trends. The seasonal models have different time periods for the seasonality. The trend models are combined with the seasonal models to form complete models that take into account the seasonality and the trends. The forecasting model is selected from the complete models in which the forecasting model is a best fit to a set of criteria.

### BACKGROUND

### 1. Field

The disclosure relates generally to an improved computer system and, more specifically, to a method, apparatus, system, and computer program product for creating forecasting models that take into account change points and seasonality in time series data.

### 2. Description of the Related Art

Forecasting is a process of making predictions of the future based on past and present data. Forecasting has many applications in business. This type of forecasting can be an important component in making strategic business decisions. For example, in the area of financial planning, a variety of forecasting use cases are present. An organization may want to forecast market share of a product years into the future. The organization may also want to forecast demand for the product into the future. These forecasts can be used to aid in making decisions such as allocating funds for production of a product or determining a price of the product itself. A forecast that is marginally more accurate can give a business the right amount of edge to win market share or allow the organization to choose the right allocation of resources to maximize profitability.

### SUMMARY

According to one embodiment of the present invention, a method creates a forecasting model for time series data. Seasonality is removed, by a computer system, from the times series data having the seasonality and trends to form deseasoned time series data. Trend models are created, by the computer system, for sets of candidate change points in the deseasoned time series data. The trend models are for the sets of candidate change points without the seasonality. Seasonal models are created, by the computer system, using the time series data without the trends. The seasonal models have different time periods for the seasonality. The trend models are combined, by the computer system, with the seasonal models to form complete models that take into account the seasonality and the trends. The forecasting model is selected, by the computer system, from the complete models in which the forecasting model is a best fit to a set of criteria.

According to another embodiment of the present invention, a forecasting model system comprising a computer system that operates to remove seasonality from the times series data having seasonality and trends to form deseasoned time series data. The computer system creates trend models for sets of candidate change points in the deseasoned time series data. The trend models are for the sets of candidate change points without the seasonality. The computer system creates seasonal models using the time series data without the trends. The seasonal models have different time periods for the seasonality. The computer system combines the trend models with the seasonal models to form complete models that take into account the seasonality and the trends. The computer system selects the forecasting model from the complete models in which the forecasting model is a best fit to a set of criteria.

According to yet another embodiment of the present invention, a computer program product for creating a forecasting model comprises a computer-readable-storage media with first program code, second program code, third program code, four program code, and fifth program code stored on the computer-readable storage media. The first program code is executable by a computer system to cause the computer system to remove seasonality from the times series data having the seasonality and trends to form deseasoned time series data. The second program code is executable by a computer system to cause the computer system to create trend models for sets of candidate change points in the deseasoned time series data. The trend models are for the sets of candidate change points without seasonality. The third program code is executable by a computer system to cause the computer system to create seasonal models using the time series data without the trends. The seasonal models have different time periods for the seasonality. The fourth program code is executable by a computer system to cause the computer system to combine the trend models with the seasonal models to form complete models that take into account the seasonality and the trends. The fifth program code is executable by a computer system to cause the computer system to select the forecasting model from the complete models in which the forecasting model is a best fit to a set of criteria.

### BRIEF DESCRIPTION OF THE DRAWINGS

FIG. 1 is a block diagram of a forecasting environment in accordance with an illustrative embodiment;

FIG. 2 is a block diagram illustrating creating a seasonality model in accordance with an illustrative embodiment;

FIG. 3 is a flowchart of a process for creating a forecasting model in accordance with an illustrative embodiment;

FIG. 4 is a more detailed flowchart of a process for removing seasonality from times series data in accordance with an illustrative embodiment;

FIG. 5 is a flowchart of a process for creating seasonal models in accordance with an illustrative embodiment;

FIG. 6 is more detailed flowchart of a process for creating a forecasting model that takes into account change points and seasonality in accordance with an illustrative embodiment;

FIG. 7 is a flowchart of a process for automated period detection for seasonality models in accordance with an illustrative embodiment; and

FIG. 8 is a block diagram of a data processing system in accordance with an illustrative embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The illustrative embodiments recognize and take into account a number of different considerations. For example, the illustrative embodiments recognize and take into account that data scientists choose model parameters for handcrafted traditional forecasting models such as AutoRegressive Integrated Moving Average (ARIMA) or exponential smoothing. The illustrative embodiments recognize and take into account that this type of expertise is not readily available to data analysts in many organizations. The illustrative embodiments recognize and take into account that tools containing automated processes have been developed to aid in choosing model parameters. The illustrative embodiments recognize and take into account that these tools often sacrifice some accuracy to provide an automated solution.

The illustrative embodiments also recognize and take into account that current tools have different levels of automation with respect to trends in seasonality detection. The illustrative embodiments also recognize and take into account that these tools do not take into account change points combined with seasonality. The change points can be changes in a trend that are greater than some threshold amount. The change points and seasonality in data are frequently present in applications such as those by financial or business applications. The illustrative embodiments recognize and take into account that the data in these applications can have a sudden disruption in a pattern. Ignoring the change points in time series data when creating forecasting models can result in forecasting models that are less accurate than desired.

Therefore, it would be desirable to have a method, apparatus, system, and computer program product that take into account at least some of the issues discussed above, as well as other possible issues. For example, it would be desirable to have a method and apparatus that overcome an issue with creating forecasting models that include change point analysis combined with seasonality analysis.

Thus, illustrative embodiments provide a method, apparatus, system, and computer program product that create forecasting models that take into account both change points and seasonality. In one illustrative example, seasonality is removed from times series data having the seasonality and trends to form deseasoned time series data. Trend models are created for sets of candidate change points in the deseasoned time series data. The trend models are for the sets of candidate change points without the seasonality. Seasonal models are created using the time series data without the trends. The seasonal models have different time periods for the seasonality. The trend models are combined with the seasonal models to form complete models that take into account the seasonality and the trends. The forecasting model is selected from the complete models in which the forecasting model is a best fit to a set of criteria.

As used herein, a “set of,” when used with reference to items means one or more items. For example, a “set of criteria” is one or more criteria.

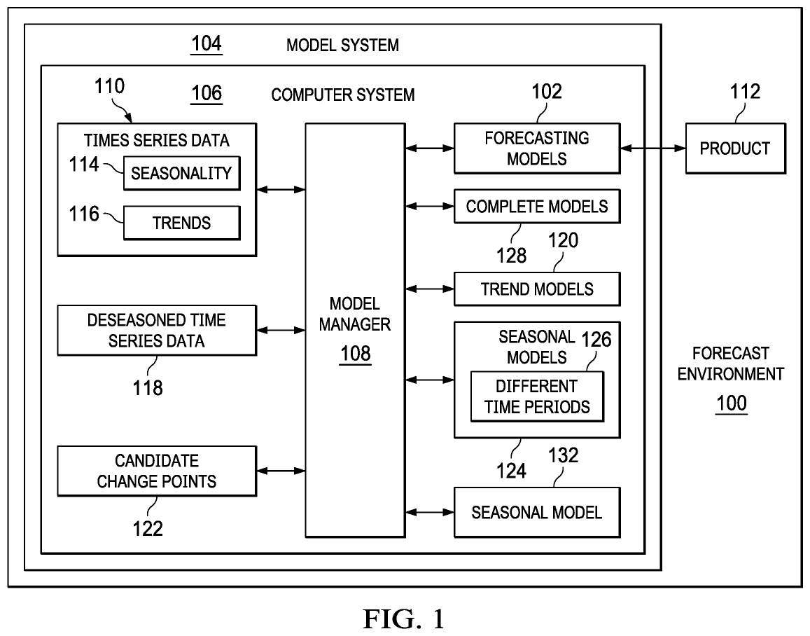

With reference now to the figures and, in particular, with reference to FIG. 1, a block diagram of a forecasting environment is depicted in accordance with an illustrative embodiment. In this illustrative example, forecast environment 100 is an environment in which forecasting models 102 can be used to make predictions such as demand forecasting. In this illustrative example, model system 104 operates to create forecasting models 102.

As depicted, model system 104 comprises computer system 106 and model manager 108. Model manager 108 is located in computer system 106.

Model manager 108 can be implemented in software, hardware, firmware, or a combination thereof. When software is used, the operations performed by model manager 108 can be implemented in program code configured to run on hardware, such as a processor unit. When firmware is used, the operations performed by model manager 108 can be implemented in program code and data and stored in persistent memory to run on a processor unit. When hardware is employed, the hardware may include circuits that operate to perform the operations in model manager 108.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of,” when used with reference to items, means one or more items. For example, “a number of different types of networks” is one or more different types of networks.

Computer system 106 is a physical hardware system and includes one or more data processing systems. When more than one data processing system is present in computer system 106, those data processing systems are in communication with each other using a communications medium. The communications medium can be a network. The data processing systems can be selected from at least one of a computer, a server computer, a tablet computer, or some other suitable data processing system.

The phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

In the illustrative example, model manager 108 in computer system 106 operates to create forecasting models 102 from time series data 110. Forecasting models 102 can be used to predict demand for product 112. These predictions can be used by an organization to make decisions such as at least one of allocating funds for production of product 112, selecting a location for manufacturing of product 112, determining a price for product 112, or other decisions.

As depicted, a product in product 112 can be a service, a physical item, and combinations thereof. Product 112 can include both good and services. For example, product 112 can include goods, such as software or a vehicle, and services, such as support or maintenance for the vehicle.

In this illustrative example, time series data 110 is a series of data points that are indexed in time order. Time series data 110 can be processed by model manager 108 to generate forecasting models 102. In this example, time series data 110 includes seasonality 114 and trends 116. In the illustrative example, seasonality 114 is time series data 110 meaning that a pattern is present in time series data 110 that repeats periodically. The period can be monthly, yearly, or some other period of time. For example, with seasonality 114, a spike in sales of product 112 can occur every December.

As depicted, trends 116 can be lines that are fit to data in time series data 110. In this illustrative example, a trend can be a pattern of behavior of data in time series data 110. When the trend is linear, the trend can be determined using techniques such as regression analysis.

Trends 116 can be represented by trend lines fit to time series data 110. When a trend is not linear, the trend can be determined by non-parametric methods such as the Mann-Kendall test. Trends 116 can indicate an increase or decrease in demand for product 112 over time.

As depicted, model manager 108 can operate to remove seasonality 114 from times series data 110 having seasonality 114 and trends 116 to form deseasoned time series data 118. In illustrative example, seasonality 114 can be removed from time series data 110 in a number of different ways using currently known techniques.

Model manager 108 can create trend models 120 for sets of candidate change points 122 in deseasoned time series data 118. In the illustrative example, trend models 120 are for sets of candidate change points 122 without seasonality 114.

In this illustrative example, a candidate change point in candidate change points 122 in time series data 110 is present when at least one of a probability distribution of the time series data changes, a data point in time series data 110 in which the statistical properties before and after the data point differ, a step occurs in the time series data in which the step is greater than a threshold for a change point, a slope in the time series data changes in an amount greater than a threshold, an anomalous change occurring in the time series data deviates from what is expected for a trend, or other types of change that can be considered a sudden change or abrupt change in time series data 110. Candidate change points 122 can include, for example, at least one of a step, a horizontal line, a change in slope in a trend, or other changes such as a change in mean, variance, correlation, spectral density, or other changes.

The detection of candidate change points 122 can be determined using known techniques such as online change detection, offline change detection, minmax change detection, and other known techniques. These techniques are used to determine what points in deseasoned time series data 118 are candidates for change points.

Further, model manager 108 can create seasonal models 124 using time series data 110 without trends 116. In this illustrative example, seasonal models 124 have different time periods 126 for seasonality 114.

As depicted, model manager 108 can combine trend models 120 with seasonal models 124 to form complete models 128 that take into account seasonality 114 and trends 116. Model manager 108 can select forecasting model 102 from complete models 128 in which forecasting model 102 is a best fit to a set of criteria. The set of criteria is selected from at least one of Akaike Information Criterion (AIC), Bayesian Information Criterion (BIC), Strengthened Schwarz Information Criterion (sSIC), Modified Bayesian Information Criterion (mBIC), Minimum Description Length (MDL), or other suitable types of criteria.

In the illustrative example, model manager 108 can remove seasonality from time series data 110 by building seasonal model 132 from time series data 110 that has seasonality 114 and without trends 116. Model manager 108 can remove seasonality 114 from times series data 110 having seasonality 114 and without trends 116 using seasonal model 132 to form deseasoned time series data 118. In some illustrative examples, seasonal model 132 can be created with trend 116 for use in deseasoning time series data 110.

Additionally, model manager 108 can determine the sets of candidate change points 122 by detecting candidate change points 122 in deseasoned time series data 118. Model manager 108 can then create the sets of candidate change points 122 from candidate change points 122 detected in deseasoned time series data 118.

Model manager 108 creates seasonal models 124 using time series data 110 without trends 116, wherein seasonal models 124 have different time periods 126 for seasonality 114. Time series data 110 without trends 116 can be different for each seasonal model in seasonal models 124. In other words, sets of time series data 110 without trends 116 can be generated in which each set of time series data 110 without trends 116 can be created using a trend model in trend models 120 in which the trend model was created using a particular set of candidate change points 122.

In this illustrative example, the particular set of candidate change points 122 is unique or different from other sets of candidate change points 122 used to generate other trend models in trend models 120. Thus, time series data 110 without trends 116 can be different for each seasonal model in seasonal models 124 because each seasonal model can be created using time series data 110 with trends 116 removed using a particular trend model that is based on a particular set of candidate change points 122.

Model manager 108 combines trends 116 with seasonal models 124 for corresponding trend models in trends 116 to form complete models 128 that take into account seasonality 114 and trends 116 and selects forecasting model 102 from complete models 128 in which forecasting model 102 is a best fit to a set of criteria. A corresponding trend model for a seasonal model is the trend model used to remove trends from time series data 110 used to create the seasonal model. In this manner, model manager 108 in computer system 106 provides a practical application for creating forecasting models such that the functioning of computer system 106 is improved in forecasting demand for product 112.

In one illustrative example, one or more solutions are present that overcome an issue with creating forecasting models that take into account both change points and seasonality. In other words, these forecasting models include trends and seasonality for forecasting demand for products. As a result, one or more solutions may provide an effect of enabling the creation of forecasting models that have increased accuracy in taking into account change points and seasonality as compared to current techniques for creating forecasting models to forecast demand for products.

Thus, the illustrative examples can create forecasting models for time series data that take into account both change points and seasonality in the time series data. As depicted, in the illustrative examples, forecasting models are created for multiple combinations of candidate change points and seasonality periods. Change points that represent the trend in a time series data can be divided in the sections that are smoothly changing within the section. Smoothly changing can be a change in the time series data that is within a selected threshold for the change. Abrupt changes can be changes that are greater than the threshold. The abrupt changes can be present at the change points in the time series data. A trend model for these trends based on change points can be combined with automatic seasonality detection. These combined models can then be evaluated using criteria for model evaluation to select a forecasting model.

Computer system 106 can be configured to perform at least one of the steps, operations, or actions described in the different illustrative examples using software, hardware, firmware, or a combination thereof. As a result, computer system 106 operates as a special purpose computer system in which model manager 108 in computer system 106 enables creating forecasting modeling 102 that takes into account both seasonality 114 and trends 116 with a higher level of accuracy in predicting demand as compared to currently used techniques. In particular, model manager 108 transforms computer system 106 into a special purpose computer system as compared to currently available general computer systems that do not have model manager 108.

In the illustrative example, the use of model manager 108 in computer system 106 integrates processes into a practical application for creating forecasting model 102 that increases the performance of computer system 106. In other words, model manager 108 in computer system 106 is directed to a practical application of processes integrated into model manager 108 in computer system 106 that creates forecasting model 102 from time series data 110 that includes seasonality 114 and trends 116 in which forecasting model 102 predicts demand for product 112 with increased accuracy. In other words, computer system 106 or some other computer system has increased accuracy in predicting demand for product 112 when using forecasting model 102 as created by model manager 108.

In this illustrative example, model manager 108 in computer system 106 enables creating forecasting models with increased accuracy as compared to forecasting models created by currently used techniques. In this illustrative example, model manager 108 removes seasonality 114 from times series data 110 having seasonality 114 and trends 116 to form deseasoned time series data 118. Additionally, model manager 108 creates trend models 120 for sets of candidate change points 122 in deseasoned time series data 118, wherein trend models 120 are for the sets of candidate change points 122 without seasonality 114. In this illustrative example, each trend model in trend models 120 is created using a different set of candidate change points 122 in sets of candidate change points 122. In other words, the set of candidate change points 122 is different for each trend model in trend models 120.

In the illustrative examples, the different trend and seasonal models described in the illustrative examples are forecasting models. For example, trend models 120, seasonal models 124, and seasonal model 132 are forecasting models that forecast demand for products.

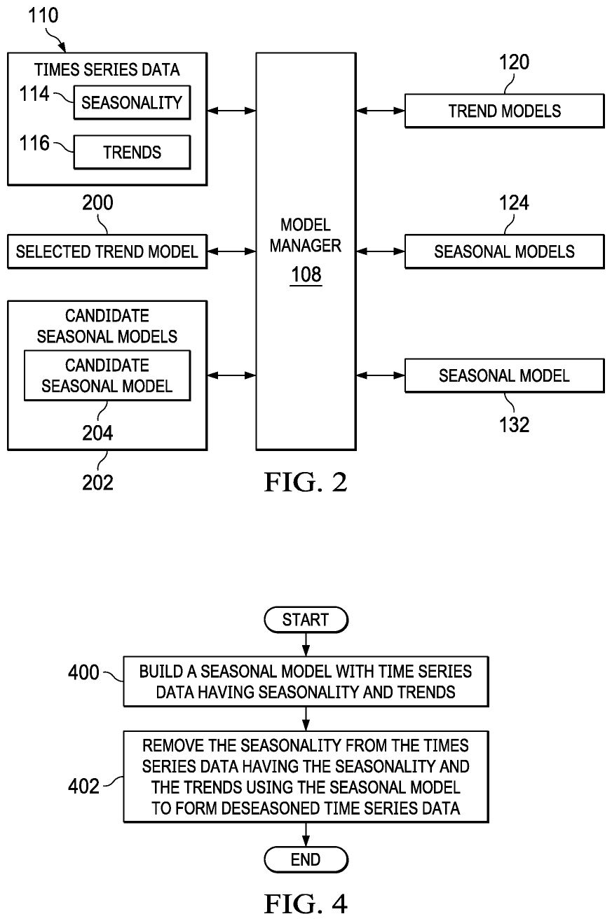

Turning now to FIG. 2, a block diagram illustrating creating a seasonality model is depicted in accordance with an illustrative embodiment. The data flow illustrated in this figure can be used to generate seasonal models such as seasonal models 124 and seasonal model 132 in FIG. 1. Model manager 108 can operate to automatically build an exponential smoothing model such as seasonal models 124 or seasonal model 132.

As depicted, model manager 108 selects a trend model from trend models 120 for use as selected trend model 200. Selected trend model 200 is a trend model that is based on a set of candidate change points 122 in FIG. 1 from sets of candidate change points 122 that were used to create the trend model selected for use as selected trend model 200. Model manager 108 can remove trends 116 from time series data 110 using selected trend model 200 to form time series data 110 without trends 116. Model manager 108 can determine different time periods 126 in FIG. 1 in times series data 110 without trends 116 in which trends 116 have been removed using selected trend model 200.

As depicted, model manager 108 can create candidate seasonal models 202 using time series data 110 without trends 116 in which candidate seasonal models 202 have different time periods 126 in FIG. 1. In the illustrative example, model manager 108 identifies different time periods 126 in time series data 110 without trends 116. Each of these different time periods is used to create a candidate seasonal model in candidate seasonal models 202.

As a result, candidate seasonal models 202 have different time periods 126 for seasonality 114. In other words, each seasonal model in seasonal models 124 has a different time period in different time periods 126 for seasonality 114 from other seasonal models 124.

In the illustrative example, model manager 108 selects candidate seasonal model 204 from candidate seasonal models 202 based on candidate seasonal model 204 having another best fit to another set of criteria. In this illustrative example, candidate seasonal model 202 is the best candidate seasonal model and can be selected using standard information criteria such as Akaike Information Criterion (AIC) which measures the fit of the model and penalizes by the complexity (number of parameters) of the candidate seasonal model. In this illustrative example, candidate seasonal model 202 has the lowest Akaike Information Criterion (AIC) selected in this illustrative example.

Candidate seasonal model 204 is a seasonal model in seasonal models 124 for selected trend model 200 in trend models 120. Candidate seasonal model 204 is considered to be a corresponding seasonal model for selected trend model 200. Model manager 108 can repeat this process for each of trend models 120 to create seasonal models 124 for use in combining with trend models 120.

Further, model manager 108 can perform the process described in FIG. 2 to create seasonal model 132 that is used to create deseasoned time series data 118 in FIG. 1. In this case, trend models 120 are not present. In this case, selected trend model 200 is created using currently known techniques. For example, selected trend model 200 can be created using exponential smoothing, regression, filters, AutoRegressive Integrated Moving Average (ARIMA), a neural network, or other techniques for each segment identified between change points. The filters can be, for example, moving average or Hodrick-Prescott (HP) filters. Other methods to model time series data in general are ARIMA and neural networks. The segments can be concatenated to create selected trend model 200. In this example, each segment comprises the time series data between two neighboring change points in time series data 110.

The illustration of forecast environment 100 in FIG. 1 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, forecasting models 102 can operate to create one or more forecasting models in addition to or in place of forecasting models 102.

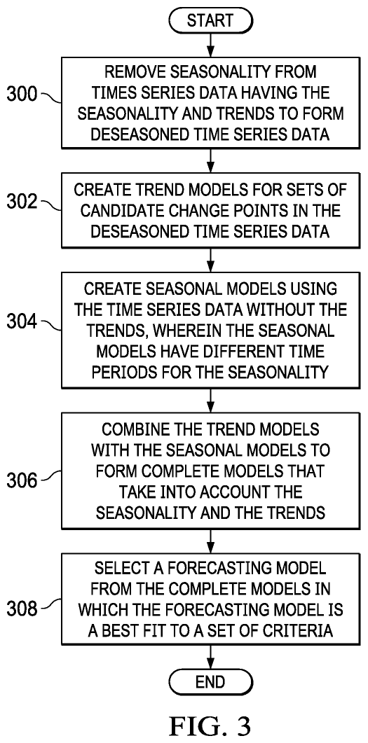

Turning next to FIG. 3, a flowchart of a process for creating a forecasting model is depicted in accordance with an illustrative embodiment. The process in FIG. 3 can be implemented in hardware, software, or both. When implemented in software, the process can take the form of program code that is run by one or more processor units located in one or more hardware devices in one or more computer systems. For example, the process can be implemented in model manager 108 in computer system 106 in FIG. 1.

The process begins by removing seasonality from times series data having seasonality and trends to form deseasoned time series data (step 300). The process creates trend models for sets of candidate change points in the deseasoned time series data (step 302). In step 302, the trend models are for the sets of candidate change points without the seasonality

The process creates seasonal models using the time series data without the trends, wherein the seasonal models have different time periods for the seasonality (step 304). The process combines the trend models with the seasonal models to form complete models that take into account the seasonality and the trends (step 306).

The process selects a forecasting model from the complete models in which the forecasting model is a best fit to a set of criteria (step 308). The process terminates thereafter.

With reference next to FIG. 4, a more detailed flowchart of a process for removing seasonality from times series data is depicted in accordance with an illustrative embodiment. The process in FIG. 4 is an example of one manner in which step 300 in FIG. 3 can be implemented.

The process beings by building a seasonal model with time series data having seasonality and trends (step 400). The process removes the seasonality from the times series data having the seasonality and the trends using the seasonal model to form deseasoned time series data (step 402). The process terminates thereafter.

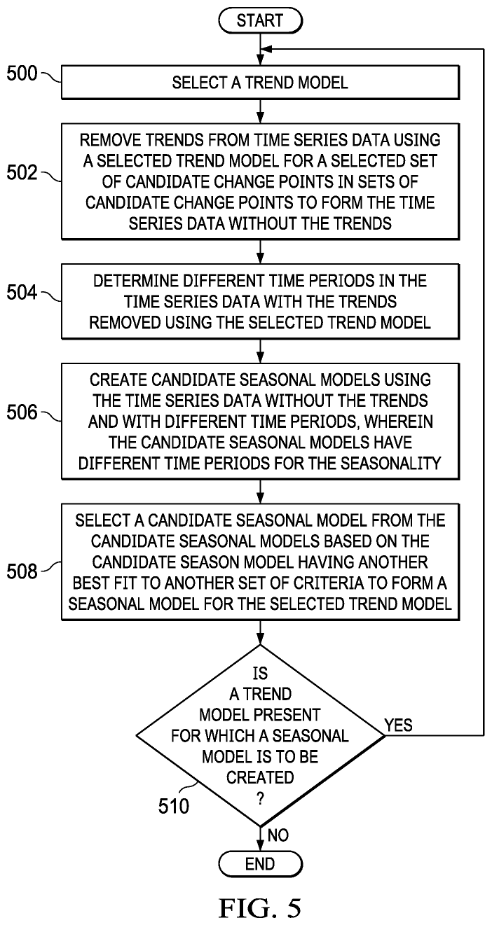

Turning now to FIG. 5, a flowchart of a process for creating seasonal models is depicted in accordance with an illustrative embodiment. The flowchart in FIG. 5 can be used to create the seasonal models in step 304 in FIG. 3 and the seasonal model in step 400 in FIG. 4.

The process begins by selecting a trend model (step 500). The process removes trends from time series data using a selected trend model for a selected set of candidate change points in sets of candidate change points to form the time series data without the trends (step 502). The process determines different time periods in the time series data with the trends removed using the selected trend model (step 504).

The process creates candidate seasonal models using the time series data without the trends and with different time periods, wherein the candidate seasonal models have different time periods for the seasonality (step 506). The process selects a candidate seasonal model from the candidate seasonal models based on the candidate seasonal model having another best fit to another set of criteria to form a seasonal model for the selected trend model (step 508).

A determination is made as to whether a trend model is present for which a seasonal model is to be created (step 510). Step 510 enables creating a seasonal model for each trend model may be present. If another trend model is present, the process returns to step 500. Otherwise, the process terminates.

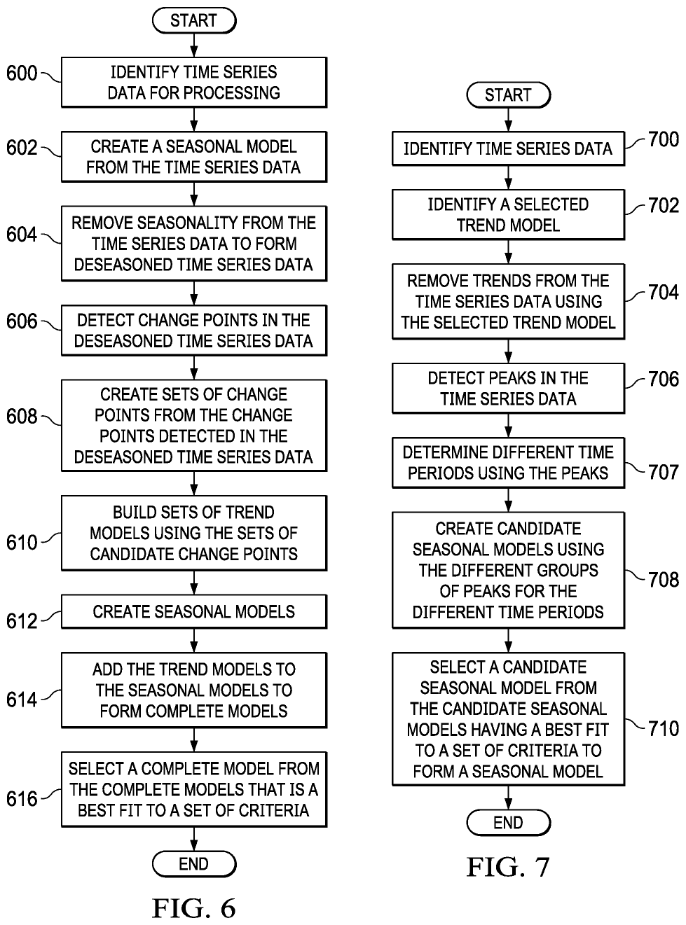

With reference now to FIG. 6, a more detailed flowchart of a process for creating a forecasting model that takes into account change points and seasonality is depicted in accordance with an illustrative embodiment. The process in FIG. 6 can be implemented in hardware, software, or both. When implemented in software, the process can take the form of program code that is run by one or more processor units located in one or more hardware devices in one or more computer systems. For example, the process can be implemented in model manager 108 in computer system 106 in FIG. 1.

The process begins by identifying time series data for processing (step 600). In step 600, the time series data identified in input selects or designates the time series data that should be processed for creating a forecasting model takes into account change points and seasonality. The input selecting or designating the time series data can be received from a human machine interface or another application.

The process creates a seasonal model from the time series data (step 602). The seasonal model is selected as the best candidate seasonal model from candidate seasonal models meeting a set of criteria as described in more detail in the flowchart in FIG. 7 below.

The process then removes seasonality from the time series data to form deseasoned time series data (step 604). The removal of seasonality from the time series data can also be referred to as deseasoning the time series data. This deseasoned time series data includes trends but not seasonality. The deseasoned time series data created in step 604 is time series data without seasonality but still has trends.

The process then detects change points in the deseasoned time series data (step 606). The process then creates sets of change points from the change points detected in the deseasoned time series data (step 608). The process then builds sets of trend models using the sets of candidate change points (step 610). In this illustrative example, a trend model is created for each set of candidate change points. The trend models include trends but do not include seasonality.

The process creates seasonal models (step 612). The seasonal models in step 612 include seasonality but not trends. The creation of the seasonal models in step 612 can be performed by fitting a best seasonal model to a trend model using automated period detection as described in FIG. 7 below.

The process then adds the trend models to the seasonal models to form complete models (step 614). In the step 614, the seasonal model added to a trend model is a seasonal model that corresponds to the trend model. The seasonal model created using time series data with trends removed by a trend model corresponds to the trend model used to remove the trends.

The process then selects a complete model from the complete models that is a best fit to a set of criteria (step 616). For example, at least one of Akaike Information Criterion (AIC), Bayesian Information Criterion (BIC), or other suitable types of criteria can be used to select the complete model. This complete model forms the forecasting model for the time series data.

Turning to FIG. 7, a flowchart of a process for automated period detection for seasonality models is depicted in accordance with an illustrative embodiment. The process in FIG. 7 can be implemented in hardware, software, or both. When implemented in software, the process can take the form of program code that is run by one or more processor units located in one or more hardware devices in one or more computer systems. For example, the process can be implemented in model manager 108 in computer system 106 in FIG. 1. In this illustrative example, the process can be used to create an exponential smoothing model with a seasonal component.

The process begins by identifying time series data (step 700). The time series data in step 700 is time series data for which a forecasting model is to be created. The process identifies a selected trend model (step 702). In this illustrative example, the selected trend model can be a trend model created in step 610 in FIG. 6 when this process is used to create a seasonal model to correspond to the trend model. When the seasonal model being created in this flowchart is the seasonal model in step 602 used in deseasoning data in step 604 in FIG. 6, a trend model can be created using current techniques for use as selected trend model.

The process removes trends from the time series data using the selected trend model (step 704). This removal of trends can also be referred to as detrending the time series data. As a result, the time series data is detrended time series data in which seasonality is still present. In other words, the trend component has been removed while the seasonal component remains in the time series data.

The process detects peaks in the time series data (step 706). The time series data between peaks can represent a period of time in which seasonality is present in the demand for a product.

The process then determines different time periods using the peaks (step 707). In other words, different groups of peaks can be selected in which the time periods between these groups of peaks represent different time periods that can be used to create a seasonal model. For example, a group of peaks can include one time period, three time periods, or some other number of time periods. Each group of peaks can be used to create a model.

As used herein, a “group of,” when used with reference to items means, one or more items. For example, a “group of peaks” is one or more peaks.

The process creates candidate seasonal models using the different groups of peaks for the different time periods (step 708). Each candidate seasonal model can have a different group of peaks such that the candidate seasonal models are created in step 708 at different time periods. Each candidate seasonal model can have one or more time periods that are different from time periods from another candidate seasonal model in the candidate seasonal models created in step 708.

The process then selects a candidate seasonal model from the candidate seasonal models having a best fit to a set of criteria to form a seasonal model (step 710). This seasonal model is a seasonal model that corresponds to the trend model identified in step 702.

This process in FIG. 7 can be repeated any number times as needed. For example, the process can be repeated any number of times to create seasonal models corresponding to trend models. The process for automatic detection of seasonal periods in FIG. 7 can be performed in a fully automatic fashion. Further, although the detection is used in step 706, other techniques can be used to identify candidate periods of time for seasonality. These techniques include, for example, an autocorrelation function, a spectral analysis using Fourier transforms, a wavelet transform, or other suitable techniques.

In the illustrative examples, the removal of at least one of seasonality or trends can be performed in a number of different ways. For example, an exponential smoothing model with a seasonal component can be created by following the steps in flowchart in FIG. 7. This exponential smoothing model with a seasonal component is also referred to as a seasonal model. The exponential smoothing model contains a seasonal component that provides the seasonal value at each time point.

If the seasonality is additive, the seasonality can be removed from time series data by subtracting the corresponding seasonal value in an exponential smoothing model at each time point from the time series data. If the model has multiplicative seasonality, then the value at each time point in the time series data is divided by the corresponding seasonal value from the exponential smoothing model. This is the process of deseasoning the data.

A similar method can be used to detrend the data. If the exponential smoothing model contains a trend component then this gives us the trend values at each time point. The time series data can be detrended by subtracting the trend values at each time point from the corresponding values of time series data.

Other techniques are present for detrending time series data. For example, differencing is a technique for detrending data that consists of creating a new data set by subtracting the value at the current time point from the value at the previous time point. Another method for removing the trends from time series data involves using a moving average filter. A moving average filter models trend. We can subtract the values obtained by the moving average filter from the corresponding values of time series data in order to detrend time series data.

Thus, the processes depicted in the flowcharts in FIG. 6 and FIG. 7 are examples of one manner in which time series data and a forecast period can be used as inputs for creating a forecasting model that takes into account trends between change points and seasonality in time series data in a manner that is more accurate as compared to current techniques.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams can be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

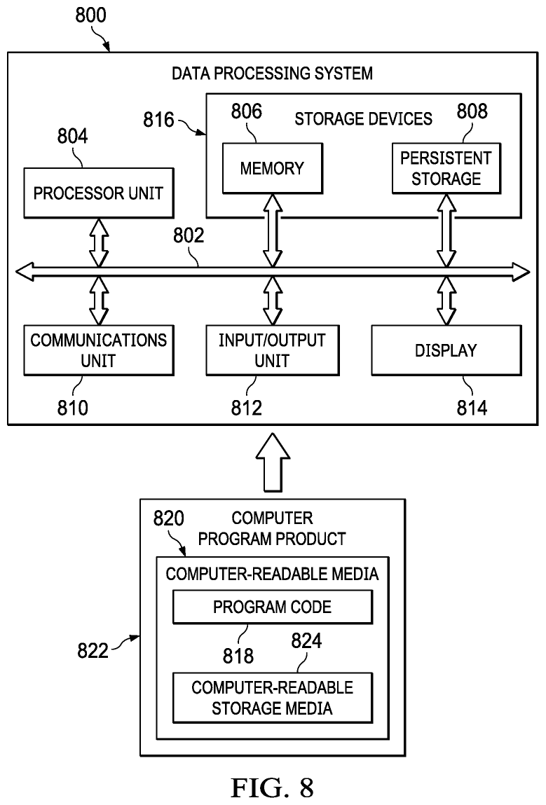

Turning now to FIG. 8, a block diagram of a data processing system is depicted in accordance with an illustrative embodiment. Data processing system 800 can be used to implement one or more data processing systems in computer system 106. In this illustrative example, data processing system 800 includes communications framework 802, which provides communications between processor unit 804, memory 806, persistent storage 808, communications unit 810, input/output (I/O) unit 812, and display 814. In this example, communications framework 802 takes the form of a bus system.

Processor unit 804 serves to execute instructions for software that can be loaded into memory 806. Processor unit 804 includes one or more processors. For example, processor unit 804 can be selected from at least one of a multicore processor, a central processing unit (CPU), a graphics processing unit (GPU), a physics processing unit (PPU), a digital signal processor (DSP), a network processor, or some other suitable type of processor. Further, processor unit 804 can may be implemented using one or more heterogeneous processor systems in which a main processor is present with secondary processors on a single chip. As another illustrative example, processor unit 804 can be a symmetric multi-processor system containing multiple processors of the same type on a single chip.

Memory 806 and persistent storage 808 are examples of storage devices 816. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 816 may also be referred to as computer-readable storage devices in these illustrative examples. Memory 806, in these examples, can be, for example, a random-access memory or any other suitable volatile or non-volatile storage device. Persistent storage 808 may take various forms, depending on the particular implementation.

For example, persistent storage 808 may contain one or more components or devices. For example, persistent storage 808 can be a hard drive, a solid-state drive (SSD), a flash memory, a rewritable optical disk, a rewritable magnetic tape, or some combination of the above. The media used by persistent storage 808 also can be removable. For example, a removable hard drive can be used for persistent storage 808.

Communications unit 810, in these illustrative examples, provides for communications with other data processing systems or devices. In these illustrative examples, communications unit 810 is a network interface card.

Input/output unit 812 allows for input and output of data with other devices that can be connected to data processing system 800. For example, input/output unit 812 may provide a connection for user input through at least one of a keyboard, a mouse, or some other suitable input device. Further, input/output unit 812 may send output to a printer. Display 814 provides a mechanism to display information to a user.

Instructions for at least one of the operating system, applications, or programs can be located in storage devices 816, which are in communication with processor unit 804 through communications framework 802. The processes of the different embodiments can be performed by processor unit 804 using computer-implemented instructions, which may be located in a memory, such as memory 806.

These instructions are referred to as program code, computer usable program code, or computer-readable program code that can be read and executed by a processor in processor unit 804. The program code in the different embodiments can be embodied on different physical or computer-readable storage media, such as memory 806 or persistent storage 808.

Program code 818 is located in a functional form on computer-readable media 820 that is selectively removable and can be loaded onto or transferred to data processing system 800 for execution by processor unit 804. Program code 818 and computer-readable media 820 form computer program product 822 in these illustrative examples. In the illustrative example, computer-readable media 820 is computer-readable storage media 824.

In these illustrative examples, computer-readable storage media 824 is a physical or tangible storage device used to store program code 818 rather than a medium that propagates or transmits program code 818.

Alternatively, program code 818 can be transferred to data processing system 800 using a computer-readable signal media. The computer-readable signal media can be, for example, a propagated data signal containing program code 818. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 820” can be singular or plural. For example, program code 818 can be located in computer-readable media 820 in the form of a single storage device or system. In another example, program code 818 can be located in computer-readable media 820 that is distributed in multiple data processing systems. In other words, some instructions in program code 818 can be located in one data processing system while other instructions in in program code 818 can be located in one data processing system. For example, a portion of program code 818 can be located in computer-readable media 820 in a server computer while another portion of program code 818 can be located in computer-readable media 820 located in a set of client computers.

The different components illustrated for data processing system 800 are not meant to provide architectural limitations to the manner in which different embodiments can be implemented. In some illustrative examples, one or more of the components may be incorporated in or otherwise form a portion of, another component. For example, memory 806, or portions thereof, may be incorporated in processor unit 804 in some illustrative examples. The different illustrative embodiments can be implemented in a data processing system including components in addition to or in place of those illustrated for data processing system 800. Other components shown in FIG. 8 can be varied from the illustrative examples shown. The different embodiments can be implemented using any hardware device or system capable of running program code 818.

Thus, illustrative embodiments of the present invention provide a computer implemented method, computer system, and computer program product for creating a forecasting model for time series data. Seasonality is removed from the times series data having the seasonality and trends to form deseasoned time series data. Trend models are created for sets of candidate change points in the deseasoned time series data. The trend models are for the sets of candidate change points without the seasonality. Seasonal models are created using the time series data without trends. The seasonal models have different time periods for the seasonality. The trend models are combined with the seasonal models to form complete models that take into account the seasonality and the trends. The forecasting model is selected from the complete models in which the forecasting model is a best fit to a set of criteria.

One or more illustrative examples overcome a problem with creating forecasting models that take into account both change points and seasonality. In other words, these forecasting models include trends and seasonality for forecasting demand for products. As a result, one or more of the illustrative examples may enable creating forecasting models that have increased accuracy in taking into account change points and seasonality as compared to current techniques for creating forecasting models to forecasting demand for products.

Thus, the illustrative examples can create forecasting models that take into account both change points and seasonality in time series data. As depicted in the illustrative examples, forecasting models are created for multiple combinations of candidate change points and seasonality periods. Change points represent the trend in a time series data and can be divided in the sections that are smoothly changing within the section. Abrupt changes can be present at the change points in the time series data. These trends based on the change points can combined with automatic seasonality detection. These combined models can then be evaluated using criteria for model evaluation to select a forecasting model.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A method for creating a forecasting model for time series data, the method comprising:
removing, by a computer system, seasonality from the times series data having the seasonality and trends to form deseasoned time series data;
creating, by the computer system, trend models for sets of candidate change points in the deseasoned time series data, wherein the trend models are for the sets of candidate change points without the seasonality;
creating, by the computer system, seasonal models using the time series data without the trends, wherein the seasonal models have different time periods for the seasonality;
combining, by the computer system, the trend models with the seasonal models to form complete models that take into account the seasonality and the trends; and
selecting, by the computer system, the forecasting model from the complete models in which the forecasting model is a best fit to a set of criteria.

2. The method of claim 1, wherein removing, by the computer system, the seasonality from the times series data having the seasonality and the trends to form the deseasoned time series data comprises:
building, by the computer system, a seasonal model with the time series data having the seasonality and the trends; and
removing, by the computer system, the seasonality from the times series data having the seasonality and the trends using the seasonal model to form the deseasoned time series data. Docket No. P201906632US01

3. The method of claim 1 further comprising:
detecting, by the computer system, candidate change points in the deseasoned time series data; and
creating, by the computer system, sets of the candidate change points from the candidate change points detected in the deseasoned time series data.

4. The method of claim 1 further comprising:
removing, by the computer system, the trends from the time series data using a selected trend model for a selected set of candidate change points in the sets of candidate change points to form the time series data without the trends;
determining, by the computer system, the different time periods in the time series data with the trends removed using the selected trend model;
creating, by the computer system, candidate seasonal models using the time series data without the trends and with the different time periods, wherein the candidate seasonal models have the different time periods for the seasonality; and
selecting, by the computer system, a candidate seasonal model from the candidate seasonal models based on the candidate seasonal model having have another best fit to another set of criteria to form a seasonal model for the selected trend model.

5. The method of claim 4 further comprising:
for each of the trend models, repeating the steps of:
removing, by the computer system, the trends from the time series data using the selected trend model for the selected set of candidate change points in the sets of candidate change points to form the time series data without the trends;
determining, by the computer system, the different time periods using the time series data with the trends removed using the selected trend model;
creating, by the computer system, the candidate seasonal models using the time series data without the trends and with the different time periods, wherein the candidate seasonal models have the different time periods for the seasonality; and
selecting, by the computer system, the candidate seasonal model from the candidate seasonal models based on the candidate seasonal model having have another best fit to another set of criteria to form the seasonal model for the selected trend model.

6. The method of claim 1, wherein the set of criteria is selected from at least one of Akaike Information Criterion or Bayesian Information Criterion.

7. The method of claim 1, wherein a candidate change point in the candidate change points in the time series data is present when at least one of a probability distribution of the time series data changes, a step occurs in the time series data, a slope in the time series data change in an amount greater than a threshold, or an anomalous change occurs in the time series data deviates from what is an expected for a trend.

8. A forecasting model system comprising:
a computer system operates to:
remove seasonality from times series data having seasonality and trends to form deseasoned time series data;
create trend models for sets of candidate change points in the deseasoned time series data, wherein the trend models are for the sets of candidate change points without the seasonality;
create seasonal models using the time series data without trends, wherein the seasonal models have different time periods for the seasonality;
combine the trend models with the seasonal models to form complete models that take into account the seasonality and the trends and; and
select the forecasting model from the complete models in which the forecasting model is a best fit to a set of criteria.

9. The forecasting model system of claim 8, wherein in removing seasonality from the times series data having the seasonality and the trends to form the deseasoned time series data, the computer system operates to:
build a seasonality model with the time series data having the seasonality and the trends; and
remove the seasonality from the times series data having the seasonality and the trends using the seasonality model to form the deseasoned time series data.

10. The forecasting model system of claim 8, wherein the computer system operates to:
detect candidate change points in the deseasoned time series data; and
create sets of the candidate change points from the candidate change points detected in the deseasoned time series data.

11. The forecasting model system of claim 8, wherein the computer system operates to:
remove the trends from the time series data using a selected trend model for a selected set of candidate change points in the sets of candidate change points to form the time series data without the trends;
determine the different time periods in the time series data with the trends removed using the selected trend model;
create candidate seasonal models using the time series data without the trends and with the different time periods, wherein the candidate seasonal models have the different time periods for the seasonality; and
select a candidate seasonal model from the candidate seasonal models based on the candidate seasonal model having have another best fit to another set of criteria to form a seasonal model for the selected trend model.

12. The forecasting model system of claim 11, wherein the computer system forms the seasonal model for each of the trend model by operating to repeat for each trend model:
removing the trends from the time series data using the selected trend model for the selected set of candidate change points in the sets of candidate change points to form the time series data without the trends;
determining the different time periods using the time series data with the trends removed using the selected trend model;
creating the candidate seasonal models using the time series data without the trends and with the different time periods, wherein the candidate seasonal models have the different time periods for the seasonality; and
selecting the candidate seasonal model from the candidate seasonal models based on the candidate seasonal model having have another best fit to another set of criteria to form the seasonal model for the selected trend model.

13. The forecasting model system of claim 8, wherein the set of criteria is selected from at least one of Akaike Information Criterion or Bayesian Information Criterion.

14. The forecasting model system of claim 8, wherein a candidate change point in the candidate change points in the time series data is present when at least one of a probability distribution of the time series data changes, a step occurs in the time series data, a slope in the time series data change in an amount greater than a threshold, or an anomalous change occurs in the time series data deviates from what is an expected for a trend.

15. A computer program product for creating a forecasting model for time series data, the computer program product comprising:
a computer-readable storage media;
first program code, stored on the computer-readable storage media, executable by a computer system to cause the computer system to remove seasonality from the times series data having the seasonality and trends to form deseasoned time series data;
second program code, stored on the computer-readable storage media, executable by a computer system to cause the computer system to create trend models for sets of candidate change points in the deseasoned time series data, wherein the trend models are for the sets of candidate change points without the seasonality;
third program code, stored on the computer-readable storage media, executable by a computer system to cause the computer system to create seasonal models using the time series data without the trends, wherein the seasonal models have different time periods for the seasonality;
fourth program code, stored on the computer-readable storage media, executable by a computer system to cause the computer system to combine the trend models with the seasonal models to form complete models that take into account the seasonality and the trends; and
fifth program code, stored on the computer-readable storage media, executable by a computer system to cause the computer system to select the forecasting model from the complete models in which the forecasting model is a best fit to a set of criteria.

16. The computer program product of claim 15, wherein the first program code comprises:
program code, stored on the computer-readable storage media, executable by a computer system to cause the computer system to build a seasonality model with the time series data having the seasonality and the trends; and
program code, stored on the computer-readable storage media, executable by a computer system to cause the computer system to remove the seasonality from the times series data having the seasonality and the trends using the seasonality model to form the deseasoned time series data.

17. The computer program product of claim 15 further comprising:
sixth program code, stored on the computer-readable storage media, executable by a computer system to cause the computer system to detect candidate change points in the deseasoned time series data; and
seventh program code, stored on the computer-readable storage media, executable by a computer system to cause the computer system to create sets of the candidate change points from the candidate change points detected in the deseasoned time series data.

18. The computer program product of claim 15 further comprising:
sixth program code, stored on the computer-readable storage media, executable by a computer system to cause the computer system to remove the trends from the time series data using a selected trend model for a selected set of candidate change points in the sets of candidate change points to form the time series data without the trends;
seventh program code, stored on the computer-readable storage media, executable by a computer system to cause the computer system to determine the different time periods in the time series data with the trends removed using the selected trend model;
eighth program code, stored on the computer-readable storage media, executable by a computer system to cause the computer system to create candidate seasonal models using the time series data without the trends and with the different time periods, wherein the candidate seasonal models have the different time periods for the seasonality; and
ninth program code, stored on the computer-readable storage media, executable by a computer system to cause the computer system to select a candidate seasonal model from the candidate seasonal models based on the candidate seasonal model having have another best fit to another set of criteria to form a seasonal model for the selected trend model.

19. The computer program product of claim 18 further comprising:
tenth program code, stored on the computer-readable storage media, executable by a computer system to cause the computer system to form the seasonal model for each of the trend model by repeating for each trend model the seventh program code, the eighth program code, and the ninth program code.

20. The computer program product of claim 15, wherein the set of criteria is selected from at least one of Akaike Information Criterion or Bayesian Information Criterion.
